(19) United States
(12) Patent Application Publication
(10) Pub. No.: US 2026/0233721 A1
(43) Pub. Date: Aug. 13, 2026

(54) HYDRAULIC PRESSURE GENERATION DEVICE

(71) Applicant: ADVICS CO., LTD., Kariya-shi, Aichi-ken (JP)

(72) Inventors: Shingo ONODA, Kariya-shi, Aichi-ken (JP); Kazutaka NORO, Kariya-shi, Aichi-ken (JP); Shikai MO, Kariya-shi, Aichi-ken (JP); Yuya MORITA, Kariya-shi, Aichi-ken (JP)

(73) Assignee: ADVICS CO., LTD., Kariya-shi, Aichi-ken (JP)

(21) Appl. No.: 19/156,446

(22) PCT Filed: Feb. 23, 2024
(86) PCT No.: PCT/JP2024/006675

§ 371 Date: Aug. 14, 2025

(30) Foreign Application Priority Data
Feb. 24, 2023 (JP) 2023-026903
Feb. 21, 2024 (JP) 2024-024501

(51) Int. Cl. B60T 11/28; B60T 13/14; B60T 13/74

(52) U.S. Cl. CPC B60T 11/28; B60T 13/142; B60T 13/148; B60T 13/745

(57) ABSTRACT

This hydraulic pressure generation device includes: an electric cylinder that is powered by an electric motor; a fifth flow path through which brake fluid in a cylinder of the electric cylinder flows toward a wheel cylinder when the brake fluid is discharged from an output port; and a resistance generation part provided in the fifth flow path. The resistance generation part is configured such that the flow resistance of the brake fluid flowing in a depressurization direction through the fifth flow path is greater than the flow resistance of the brake fluid flowing in a pressurization direction through the fifth flow path.

### TECHNICAL FIELD

The disclosure here relates to a hydraulic pressure generation device that adjusts hydraulic pressure in a wheel cylinder.

### BACKGROUND ART

Patent Literature 1 discloses an electric braking device including an electric cylinder powered by an electric motor. The device includes a cylinder, a piston that moves forward and backward within the cylinder, and a conversion mechanism that converts the rotational motion of the electric motor into linear motion and outputs the linear motion to the piston. A hydraulic chamber is defined within the cylinder by the piston. The movement direction of the piston to reduce the volume of the hydraulic chamber is defined as the forward direction, and the direction opposite to the forward direction is defined as the backward direction.

The conversion mechanism has a nut that rotates in synchronization with the rotation of the electric motor, and a screw shaft that moves linearly in accordance with the rotation of the nut. When the drive of the electric motor is transmitted to the piston via the conversion mechanism, the piston moves linearly in the forward direction. Then the brake fluid is discharged from the hydraulic chamber, so that the brake fluid is supplied to a wheel cylinder. As a result, hydraulic pressure is generated in the wheel cylinder, thereby generating a braking force on the vehicle wheels.

### CITATIONS LIST

### Patent Literature

Patent Literature 1: JP 2016-88225 A

### SUMMARY

### Technical Problems

In the electric braking device such as described above, when the power supply from the power source to the electric motor is cut off while hydraulic pressure is being generated in the wheel cylinder, the brake fluid in the wheel cylinder flows out toward the electric cylinder. The brake fluid then flows with force into the hydraulic chamber in the cylinder of the electric cylinder, causing the piston and screw shaft to move linearly in the backward direction. At this time, the screw shaft forcefully collides with a cover member that restricts the linear movement of the screw shaft in the backward direction. For this reason, the cover member is designed so as to be able to withstand the collision between the screw shaft and the cover member. This results in an increase in the size of the cover member, which in turn increases the size of the hydraulic pressure generation device itself.

### Solutions to Problems

A hydraulic pressure generation device for addressing the above problems adjusts the hydraulic pressure in a wheel cylinder provided in a vehicle. This hydraulic pressure generation device includes an electric cylinder configured to discharge brake fluid from inside the cylinder to the outside through an output port by moving a piston within the cylinder in response to driving of an electric motor, and a supply flow path through which the brake fluid flows toward the wheel cylinder when the brake fluid in the cylinder is discharged from the output port. Among the flow directions of brake fluid in the supply flow path, the flow of brake fluid toward the wheel cylinder is the pressurization direction, and the direction opposite to the pressurization direction is the depressurization direction. The supply flow path is provided with a resistance generation part that is configured such that the flow resistance of the brake fluid flowing in the depressurization direction through the supply flow path is greater than the flow resistance of the brake fluid flowing in the pressurization direction through the supply flow path.

In the above hydraulic pressure generation device, when the electric motor is driven, the piston moves in the forward direction within the cylinder of the electric cylinder. As a result, the brake fluid is discharged from inside the cylinder to the outside through the output port. Then the brake fluid flows in the pressurization direction through the supply flow path, so that the brake fluid is supplied to the wheel cylinder. As a result, the hydraulic pressure in the wheel cylinder is increased. In such a situation, when the power supply from the power source to the electric motor is cut off, the brake fluid flows in the depressurization direction through the supply flow path. Then, the flow resistance of the resistance generation part provided in the supply flow path becomes greater than when the brake fluid flows in the pressurization direction through the supply flow path. As a result, since the flow rate of the brake fluid entering the cylinder from the output port can be reduced, it is possible to suppress the rapid movement of the piston in the backward direction. Therefore, the above hydraulic pressure generation device can minimize damage to a restriction member that restricts the movement of the piston in the backward direction, when the restriction member collides with the piston or a member that is displaced in synchronization with the piston.

### BRIEF DESCRIPTION OF DRAWINGS

FIG. 1 is a schematic configuration diagram illustrating a braking device including a hydraulic pressure generation device according to a first embodiment.

FIG. 2 is a schematic diagram illustrating the configuration of an electric cylinder, a part of a supply circuit for brake fluid discharged from the electric cylinder, and the configuration of a control device in the hydraulic pressure generation device according to the first embodiment.

FIG. 3 is a sectional view illustrating the schematic configuration of a resistance generation part included in the hydraulic pressure generation device according to the first embodiment.

FIG. 4 is a schematic diagram illustrating a first valve seat of the resistance generation part in FIG. 3.

FIG. 5 is a plan view illustrating a second valve seat of the resistance generation part in FIG. 3.

FIG. 6 is a flowchart illustrating the flow of processing executed by the control device in FIG. 2.

FIG. 7 is a schematic sectional view illustrating a resistance generation part included in a hydraulic pressure generation device according to a second embodiment.

FIG. 8 illustrates the relationship between the depressurization rate and the flow resistance in the resistance generation part in FIG. 7.

FIG. 9 is a schematic diagram illustrating a modification of the resistance generation part included in the hydraulic pressure generation device according to the second embodiment.

FIG. 10 is a schematic configuration diagram illustrating a modification of the hydraulic pressure generation device.

### DESCRIPTION OF EMBODIMENTS

### First Embodiment

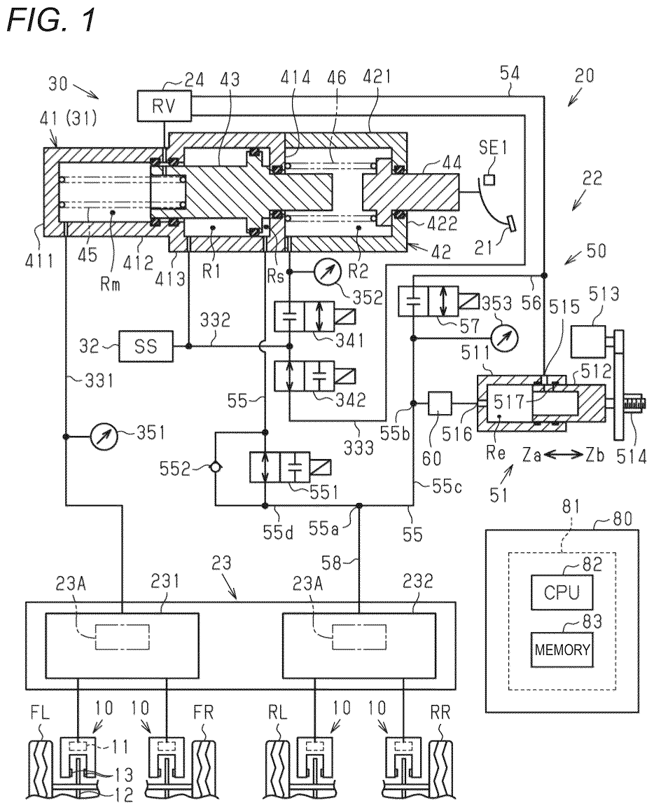

Hereinafter, a first embodiment of a hydraulic pressure generation device mounted on a vehicle will be described with reference to FIGS. 1 to 6.

FIG. 1 illustrates a plurality of wheels FL, FR, RL, and RR, a plurality of friction braking mechanisms 10, and a braking device 20. The plurality of wheels FL, FR, RL, and RR include two front wheels FL and FR and two rear wheels RL and RR.

### Configuration of Friction Braking Mechanism

A single friction braking mechanism 10 is provided for each wheel. Each of the plurality of friction braking mechanisms 10 has a wheel cylinder 11 to which brake fluid is supplied, a rotating body 12 that rotates integrally with the single wheel, and a friction material 13 that is pressed against the rotating body 12. The friction braking mechanism 10 is configured such that the greater the hydraulic pressure in the wheel cylinder 11, the more strongly the friction material 13 can be pressed against the rotating body 12. The friction braking mechanism 10 generates a braking force corresponding to the hydraulic pressure in the wheel cylinder 11.

The vehicle has a plurality of the wheel cylinders 11. In the present embodiment, among the plurality of wheel cylinders 11, the wheel cylinders 11 for the front wheels FL and FR correspond to “first wheel cylinders”, and the wheel cylinders 11 for the rear wheels RL and RR correspond to “second wheel cylinders”. That is, the vehicle has the plurality of first wheel cylinders and the plurality of second wheel cylinders.

### Configuration of Braking Device

The braking device 20 adjusts the braking force generated on the vehicle by supplying brake fluid to the wheel cylinders 11 of the plurality of friction braking mechanisms 10. The braking device 20 includes a brake operation member 21, a hydraulic pressure generation device 22, a brake actuator 23, a reservoir tank 24, and a control device 80.

The brake operation member 21 can be operated by the driver of the vehicle. An example of the brake operation member 21 is a brake pedal.

The reservoir tank 24 stores brake fluid. The interior of the reservoir tank 24 is open to the atmosphere.

The hydraulic pressure generation device 22 adjusts the hydraulic pressure in the plurality of wheel cylinders 11. The hydraulic pressure generation device 22 includes a master device 30 and a pressure adjustment unit 50. The master device 30 can supply brake fluid to the brake actuator 23. The pressure adjustment unit 50 can supply brake fluid to both the master device 30 and the brake actuator 23.

### Master Device

The master device 30 includes a master cylinder 31, a stroke simulator 32, a plurality of flow paths 331, 332, and 333 connected to the master cylinder 31, and a plurality of control valves 341 and 342 that control the flow of brake fluid. The stroke simulator 32 is capable of generating a reaction force corresponding to the amount of operation of the brake operation member 21.

The master cylinder 31 includes a main cylinder 41 and a cover cylinder 42. The master cylinder 31 includes a master piston 43 and an input piston 44. The master cylinder 31 includes a master spring 45 that biases the master piston 43, and an input spring 46 that biases the input piston 44. The master piston 43 and the input piston 44 can move relative to the main cylinder 41 and the cover cylinder 42.

The main cylinder 41 of the master cylinder 31 has a plate-shaped bottom wall 411 and a first peripheral wall 412 extending from the bottom wall 411 along the axis of the bottom wall 411. The main cylinder 41 further has a second peripheral wall 413 extending from the rear end of the first peripheral wall 412 along the axis of the first peripheral wall 412, and a first annular wall 414 extending from the rear end of the second peripheral wall 413 toward the axis of the second peripheral wall 413. Each of the first peripheral wall 412 and the second peripheral wall 413 is cylindrical. A hole into which the rear end of the master piston 43 described later is inserted is formed in the first annular wall 414. The inner diameter of the first peripheral wall 412 is smaller than the inner diameter of the second peripheral wall 413.

Inside the main cylinder 41, a master chamber Rm is defined by the bottom wall 411, the first peripheral wall 412, and the master piston 43. Hereinafter, in the master cylinder 31, the leftward direction in FIG. 1, that is, the movement direction of the master piston 43 to reduce the volume of the master chamber Rm is referred to as “forward” , while the direction opposite to forward is referred to as “rearward.” Rearward is also the direction to increase the volume of the master chamber Rm.

Inside the main cylinder 41, a first fluid chamber R1 is defined by the second peripheral wall 413 and the master piston 43, and a servo chamber Rs is defined by the second peripheral wall 413, the first annular wall 414, and the master piston 43. The master chamber Rm is formed at a position near the front end of the master cylinder 31. The first fluid chamber R1 is formed rearward of the master chamber Rm. The servo chamber Rs is formed rearward of the first fluid chamber R1. Inside the main cylinder 41, the master chamber Rm, the first fluid chamber R1, and the servo chamber Rs are not connected to each other. Furthermore, the cross-sectional area of the master chamber Rm is equal to the cross-sectional area of the servo chamber Rs. Here, the cross-sectional area of the servo chamber Rs is the cross-sectional area of the servo chamber Rs with the master piston 43 housed therein. Note that the “cross-sectional area” referred to herein is a cross section taken in a direction perpendicular to the axial direction of the master cylinder 31.

The cover cylinder 42 of the master cylinder 31 has a cylindrical third peripheral wall 421 and a second annular wall 422 that extends from the rear end of the third peripheral wall 421 toward the axis of the third peripheral wall 421. The third peripheral wall 421 is attached to the first annular wall 414 such that the axis thereof coincides with that of the second peripheral wall 413 of the main cylinder 41. The second annular wall 422 is provided with a hole into which the rear end of the input piston 44 described later is inserted.

Inside the cover cylinder 42, a second fluid chamber R2 is defined by the third peripheral wall 421, the second annular wall 422, and the first annular wall 414 of the main cylinder 41. In the master cylinder 31, the second fluid chamber R2 is formed rearward of the servo chamber Rs.

The master piston 43 is housed within the master cylinder 31 in surface contact with the inner peripheral surface of the first peripheral wall 412, the inner peripheral surface of the second peripheral wall 413, and the inner peripheral surface of the first annular wall 414 of the main cylinder 41. Therefore, when the master piston 43 moves in the axial direction, the master piston 43 slides against the inner peripheral surface of the first peripheral wall 412, the inner peripheral surface of the second peripheral wall 413, and the inner peripheral surface of the first annular wall 414. The rear end of the master piston 43 protrudes further rearward than the first annular wall 414 and is located within the second fluid chamber R2. The area of the rear end of the master piston 43 (area subjected to axial force due to the hydraulic pressure in the second fluid chamber R2) is equal to the cross-sectional area of the first fluid chamber R1. Here, the cross-sectional area of the first fluid chamber R1 is the cross-sectional area of the first fluid chamber R1 with the master piston 43 housed therein.

The input piston 44 is housed within the master cylinder 31 in surface contact with the inner peripheral surface of the second annular wall 422 of the cover cylinder 42. Therefore, when the input piston 44 moves in the axial direction, the input piston 44 slides against the inner peripheral surface of the second annular wall 422. The rear end of the input piston 44 protrudes further rearward than the second annular wall 422. The area of the tip of the input piston 44 is equal to the area of the rear end of the master piston 43. In addition, the brake operation member 21 is coupled to the rear end of the input piston 44. Thus, the input piston 44 moves in a direction approaching the master piston 43 in accordance with the amount of operation of the brake operation member 21. Furthermore, in the second fluid chamber R2, a gap is formed between the input piston 44 and the master piston 43.

The master spring 45 is disposed in the master chamber Rm of the main cylinder 41. The master spring 45 biases the master piston 43 rearward. Therefore, when the master piston 43 moves forward, the master spring 45 is elastically compressed.

The input spring 46 is disposed in the second fluid chamber R2 of the cover cylinder 42. The input spring 46 biases the input piston 44 rearward. Therefore, when the input piston 44 moves forward, the input spring 46 is elastically compressed.

In the master cylinder 31, the master chamber Rm is connected to the reservoir tank 24. Specifically, the part of the master chamber Rm toward the rear end is connected to the reservoir tank 24 via a port formed in the first peripheral wall 412 of the main cylinder 41. For this reason, if the master piston 43 moves forward from the initial position illustrated in FIG. 1, the master chamber Rm and the reservoir tank 24 are no longer connected. As a result, as the master piston 43 moves forward, the hydraulic pressure in the master chamber Rm increases. For example, when the hydraulic pressure in the servo chamber Rs increases, the master piston 43 moves forward due to the hydraulic pressure in the servo chamber Rs. This increases the hydraulic pressure in the master chamber Rm.

The first flow path 331 connects the master chamber Rm to the brake actuator 23. Specifically, the first flow path 331 connects the master chamber Rm to the wheel cylinders 11 for the front wheels FL and FR. The second flow path 332 connects the first fluid chamber R1 to the second fluid chamber R2. The third flow path 333 connects the reservoir tank 24 to the second flow path 332.

The first control valve 341 is a normally closed solenoid valve. The second control valve 342 is a normally open solenoid valve. The first control valve 341 is disposed between the connection point of the second flow path 332 with the third flow path 333 and the second fluid chamber R2. The second control valve 342 is provided in the third flow path 333. When the control device 80 of the braking device 20 is in operation, the first control valve 341 is open and the second control valve 342 is closed.

The stroke simulator 32 is disposed between the first fluid chamber R1 and the first control valve 341 in the second flow path 332. For example, the stroke simulator 32 has a piston (not illustrated) therein that is biased from the back by a spring. In this case, when the brake fluid flows in from the second flow path 332 and the piston inside is displaced against the bias of the spring, the stroke simulator 32 generates a pressure in the brake fluid in accordance with the displacement of the piston. Specifically, when, with the first control valve 341 open and the second control valve 342 closed, the input piston 44 is moved forward by the operation of the brake operation member 21, the volume of the second fluid chamber R2 decreases by the volume of the input piston 44 entering the second fluid chamber R2. Thus, the brake fluid flowing out from the second fluid chamber R2 to the second flow path 332 flows into the stroke simulator 32. As a result, the stroke simulator 32 generates the same pressure in the second fluid chamber R2 and the first fluid chamber R1 connected by the second flow path 332. Since the area of the rear end of the master piston 43 protruding into the second fluid chamber R2 is equal to the cross-sectional area of the first fluid chamber R1, in a state where the same pressure is generated in the second fluid chamber R2 and the first fluid chamber R1, the master piston 43 is not moved in the axial direction by this pressure.

### Pressure Adjustment Unit

The pressure adjustment unit 50 includes an electric cylinder 51. The pressure adjustment unit 50 can adjust the hydraulic pressure in the plurality of wheel cylinders 11 by actuating the electric cylinder 51.

The pressure adjustment unit 50 includes a fourth flow path 54, a fifth flow path 55, and a sixth flow path 58. The fourth flow path 54 connects the electric cylinder 51 to the reservoir tank 24. The fifth flow path 55 connects the servo chamber Rs of the master cylinder 31 to the electric cylinder 51. The sixth flow path 58 connects the brake actuator 23 to the fifth flow path 55. In the present embodiment, the sixth flow path 58 corresponds to a “second hydraulic flow path” for supplying brake fluid to a second hydraulic circuit 232 to be described later.

The electric cylinder 51 is provided between the fourth flow path 54 and the fifth flow path 55. The fourth flow path 54 is connected to an input port 515 of the electric cylinder 51. The fifth flow path 55 is connected to an output port 516 of the electric cylinder 51. The part of the fifth flow path 55 to which the sixth flow path 58 is connected is a first connection point 55a. A differential pressure adjustment valve 551 and a check valve 552 are provided in the part of the fifth flow path 55 closer to the servo chamber Rs than the first connection point 55a. The differential pressure adjustment valve 551 is a solenoid valve that adjusts the differential pressure between the part of the fifth flow path 55 closer to the servo chamber Rs than the differential pressure adjustment valve 551 and the part of the fifth flow path 55 closer to the electric cylinder 51 than the differential pressure adjustment valve 551. That is, the differential pressure adjustment valve 551 can adjust the amount of brake fluid to be supplied to the servo chamber Rs.

Hereinafter, the hydraulic pressure in the part of the fifth flow path 55 closer to the electric cylinder 51 than the differential pressure adjustment valve 551 will be referred to as the “first hydraulic pressure.” The hydraulic pressure in the part of the fifth flow path 55 closer to the servo chamber Rs than the differential pressure adjustment valve 551 will be referred to as the “second hydraulic pressure.” The first hydraulic pressure is the hydraulic pressure in the sixth flow path 58, and the second hydraulic pressure is also the hydraulic pressure in the servo chamber Rs.

The check valve 552 is provided in parallel with the differential pressure adjustment valve 551 in the fifth flow path 55. The check valve 552 allows the flow of brake fluid from the servo chamber Rs toward the electric cylinder 51 and restricts the flow of brake fluid from the electric cylinder 51 toward the servo chamber Rs. Specifically, if the second hydraulic pressure is greater than the first hydraulic pressure, the check valve 552 allows the brake fluid to flow toward the sixth flow path 58 Meanwhile, if the second hydraulic pressure is smaller than the first hydraulic pressure, the check valve 552 restricts the brake fluid from flowing toward the servo chamber Rs.

The part of the fifth flow path 55 closer to the electric cylinder 51 than the first connection point 55a is a “connection flow path 55c” connected to the output port 516. The part of the fifth flow path 55 on the opposite side of the first connection point 55a from the connection flow path 55c is a “first hydraulic flow path 55d” for supplying brake fluid to a first hydraulic circuit 231 to be described later. That is, the part of the fifth flow path 55 between the connection point with the servo chamber Rs and the first connection point 55a is the first hydraulic flow path 55d. In this case, it can be said that both the sixth hydraulic pressure flow path 58 corresponding to the second hydraulic flow path and the first hydraulic flow path 55d are connected to the connection flow path 55c via the first connection point 55a.

The pressure adjustment unit 50 includes a release flow path 56 and a release valve 57 disposed in the release flow path 56. The release flow path 56 connects the reservoir tank 24 to the wheel cylinder 11 so as to bypass the electric cylinder 51. The first end of the release flow path 56 is connected to the fourth flow path 54, while the second end of the release flow path 56 is connected to the fifth flow path 55. Specifically, the release flow path 56 connects the part of the fourth flow path 54 between the reservoir tank 24 and the input port 515 to the part of the fifth flow path 55 between the first connection point 55a and the output port 516. The part of the fifth flow path 55 to which the release flow path 56 is connected is a second connection point 55b. The second connection point 55b is disposed such that the first connection point 55a is located between the second connection point 55b and the differential pressure adjustment valve 551.

The release valve 57 is a normally closed solenoid valve. Therefore, if control for opening the release valve 57 is not performed, the release flow path 56 is closed.

The pressure adjustment unit 50 includes a resistance generation part 60. The resistance generation part 60 is disposed in the connection flow path 55c. Specifically, the resistance generation part 60 is disposed in the part of the connection flow path 55c closer to the electric cylinder 51 than the second connection point 55b. The configuration of the resistance generation part 60 will be described later.

### Configuration of Electric Cylinder

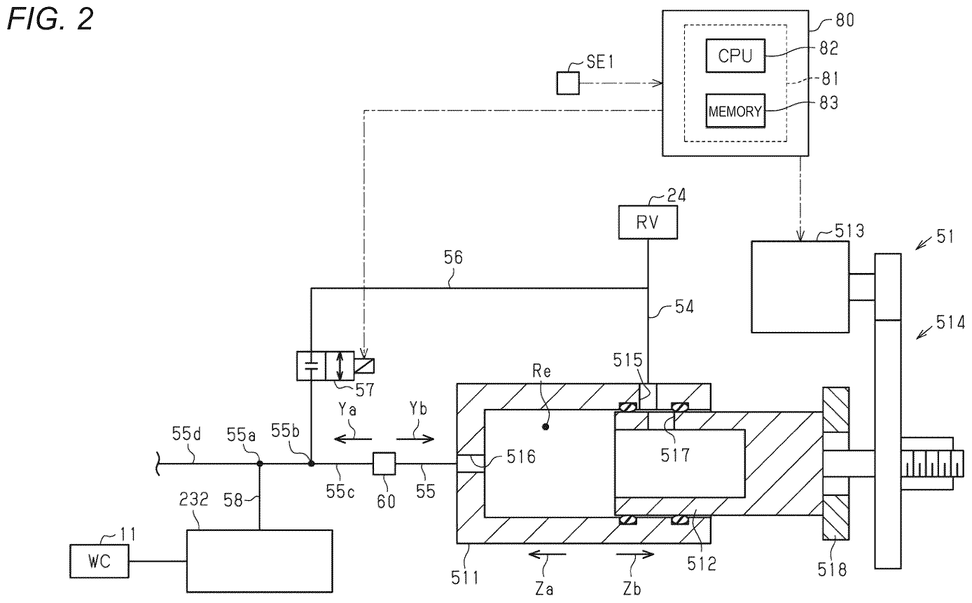

As illustrated in FIGS. 1 and 2, the electric cylinder 51 includes a cylinder 511, a piston 512, an electric motor 513, and a conversion mechanism 514. The piston 512 is provided so as to be slidable within the cylinder 511. The electric motor 513 is a power source for the electric cylinder 51. The conversion mechanism 514 converts the rotational motion of the output shaft of the electric motor 513 into the linear motion of the piston 512.

Inside the cylinder 511, a hydraulic chamber Re into which brake fluid is introduced is defined by the peripheral wall of the cylinder 511 and the piston 512. The position of the piston 512 inside the cylinder 511 can be changed by driving the electric motor 513. Hereinafter, the movement direction of the piston 512 to reduce the volume of the hydraulic chamber Re is referred to as the “forward direction Za.” The direction opposite to the forward direction Za is referred to as the “backward direction Zb.” The backward direction Zb is also the movement direction of the piston 512 to increase the volume of the hydraulic chamber Re.

As illustrated in FIG. 2, a restriction member 518 that restricts the movement of the piston 512 in the backward direction Zb is disposed in the backward direction Zb relative to the piston 512. For example, the restriction member 518 is an elastic body such as a disc spring. When the piston 512 moves in the backward direction Zb and comes into contact with the restriction member 518, further movement of the piston 512 in the backward direction Zb is restricted by the restriction member 518. The position of the piston 512 at which further movement in the backward direction Zb is restricted by the restriction member 518 is referred to as the backward limit position, which is the rearmost position in the backward direction Zb within the movable range of the piston 512.

In the peripheral wall of the cylinder 511, the input port 515 and the output port 516 are formed as ports connecting the hydraulic chamber Re to the outside. A through-hole 517 is formed in the piston 512. When the position of the piston 512 in the absence of a braking request for the vehicle is the standby position and the piston 512 is located in the standby position or in the backward direction Zb relative to the standby position, the through-hole 517 allows communication between the input port 515 and the hydraulic chamber Re. Thus, when the piston 512 is located in the standby position, the hydraulic chamber Re of the cylinder 511 communicates with the fourth flow path 54 via the input port 515 and the through-hole 517. That is, the hydraulic chamber Re of the cylinder 511 communicates with the reservoir tank 24 via the input port 515 and the through—hole 517. The input port 515 is configured to be open when the piston 512 is located in the standby position, and to be closed by the piston 512 when the piston 512 is moved in the forward direction Za from the standby position. Even with the input port 515 closed by the piston 512 in this manner, when the piston 512 moves in the forward direction Za, the hydraulic pressure in the hydraulic chamber Re increases.

The output port 516 of the cylinder 511 is connected to the master device 30 and the sixth flow path 58 via the fifth flow path 55. The output port 516 is always open, regardless of the position of the piston 512. Therefore, when the piston 512 moves in the forward direction Za with the input port 515 closed by the piston 512, the brake fluid in the hydraulic chamber Re is discharged from the output port 516 to the outside of the cylinder 511. That is, the fifth flow path 55 is one of the “supply flow paths” through which the brake fluid flows toward the wheel cylinder 11 when the brake fluid in the cylinder 511 is discharged from the output port 516.

Note that the electric cylinder 51 of the braking device 20 does not include a spring that biases the piston 512 in the backward direction Zb. The electric cylinder 51 may include a spring that biases the piston 512 in the backward direction Zb.

### Configuration of Resistance Generation Part

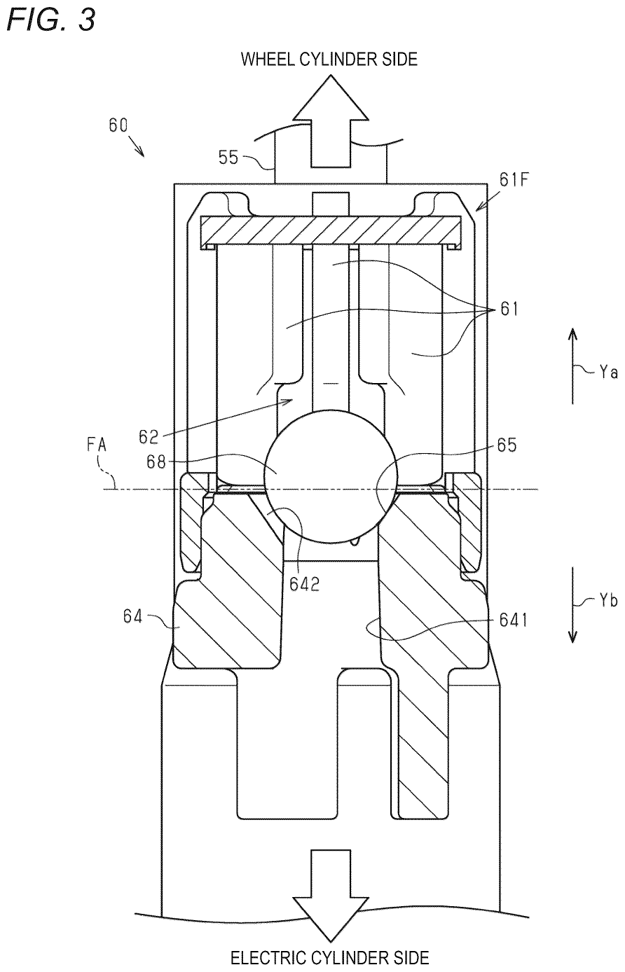

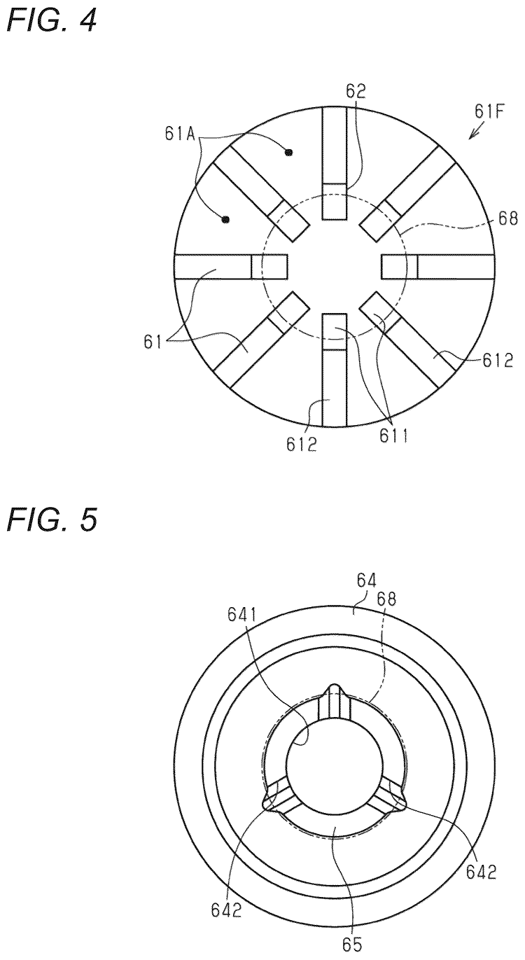

The configuration of the resistance generation part 60 will be described with reference to FIGS. 3, 4, and 5. Note that in the flow direction of the brake fluid in the fifth flow path 55, the flow of the brake fluid toward the wheel cylinder 11 is a “pressurization direction Ya”, and the direction opposite to the pressurization direction Ya is a “depressurization direction Yb”. Note that FIG. 4 is a plan view schematically illustrating a support filter 61F viewed from a virtual plane FA in a case where the resistance generation part 60 is cut on the virtual plane FA perpendicular to the flow direction of the brake fluid. FIG. 5 is a plan view of a seat member 64 viewed from the virtual plane FA in a case where the resistance generation part 60 is cut on the virtual plane FA.

The resistance generation part 60 is configured such that the flow resistance of the brake fluid flowing in the depressurization direction Yb through the fifth flow path 55 is greater than the flow resistance of the brake fluid flowing in the pressurization direction Ya through the fifth flow path 55. Specifically, the resistance generation part 60 includes the support filter 61F, the seat member 64 disposed in the depressurization direction Yb relative to the support filter 61F, and a valve element 68.

As illustrated in FIGS. 3 and 4, the support filter 61F has a plurality of support members 61 arranged in circumferentially spaced relation. For example, the plurality of support members 61 are arranged at equally spaced intervals in the circumferential direction. A flow path through which the brake fluid flows is formed inward of the plurality of support members 61. The plurality of support members 61 are formed with support parts 611 for supporting the valve element 68. The plurality of support parts 611 form a first valve seat 62 on which the valve element 68 is seated. The first valve seat 62 is disposed in the pressurization direction Ya relative to the valve element 68. When the brake fluid flows in the pressurization direction Ya through the fifth flow path 55, the valve element 68 is displaced in the pressurization direction Ya. Then the valve body 68 is seated on the first valve seat 62.

A guide part 612 protruding toward the seat member 64 is formed on each of the plurality of support members 61 further outward in the radial direction than the support part 611. When the brake fluid flows through the fifth flow path 55, the valve element 68 is displaced inside the plurality of guide parts 612 in accordance with the flow of the brake fluid.

Note that in FIG. 4, the valve element 68 seated on the first valve seat 62 is indicated by a two-dot chain line. As illustrated in FIG. 4, even when the valve element 68 is seated on the first valve seat 62, the brake fluid flows between two support members 61 that are adjacent to each other in the circumferential direction. When the part formed by the two support members 61 that are adjacent to each other in the circumferential direction and the valve element 68 seated on the first valve seat 62 is defined as a circulation part 61A, the circulation part 61A is formed to have a flow path cross-sectional area that does not interfere with increasing the hydraulic pressure in the plurality of wheel cylinders 11 by the operation of the electric cylinder 51.

As illustrated in FIGS. 3 and 5, the seat member 64 is formed with a second valve seat 65 on which the valve element 68 is seated, a through-hole 641, and a plurality of grooves 642 communicating with the through-hole 641. The through-hole 641 extends in the axial direction of the seat member 64. Each of the plurality of grooves 642 extends radially outward from the communication part with the through-hole 641. The second valve seat 65 is located in the depressurization direction Yb relative to the first valve seat 62. Therefore, when the brake fluid flows in the depressurization direction Yb through the fifth flow path 55, the valve element 68 displaced in the depressurization direction Yb is seated on the second valve seat 65. When the valve element 68 is seated on the second valve seat 65, the through-hole 641 is closed by the valve element 68, while the plurality of grooves 642 formed in the second valve seat 65 are not closed. Therefore, the circulation of brake fluid through the plurality of grooves 642 is permitted. However, the flow path cross-sectional area of the groove 642 is sufficiently smaller than the flow path cross-sectional area of the circulation part 61A. Therefore, the flow resistance of the brake fluid flowing in the depressurization direction Yb through the resistance generation part 60 is greater than the flow resistance of the brake fluid flowing in the pressurization direction Ya through the resistance generation part 60.

Note that if the brake fluid flows in the pressurization direction Ya through the fifth flow path 55, the valve element 68 is separated from the second valve seat 65. With the valve element 68 separated from the second valve seat 65 in this manner, the through-hole 641 is not closed. As a result, in the resistance generation part 60, the flow path cross-sectional area through which the brake fluid flows is larger than when the valve element 68 is seated on the second valve seat 65. Therefore, when the brake fluid flows in the pressurization direction Ya through the fifth flow path 55, the flow rate of the brake fluid passing through the resistance generation part 60 is not reduced.

The valve element 68 is, for example, a sphere. The valve element 68 is disposed between the first valve seat 62 and the second valve seat 65. Then the valve element 68 is displaced in a direction corresponding to the flow direction of the brake fluid in the fifth flow path 55 between the first valve seat 62 and the second valve seat 65. That is, when the brake fluid flows in the pressurization direction Ya through the fifth flow path 55, the valve element 68 is separated from the second valve seat 65 and is displaced in the pressurization direction Ya until seated on the first valve seat 62. Therefore, when the brake fluid flows in the pressurization direction Ya through the fifth flow path 55, the valve element 68 is separated from the seat member 64. Meanwhile, when the brake fluid flows in the depressurization direction Yb through the fifth flow path 55, the valve element 68 is separated from the first valve seat 62 and is displaced in the depressurization direction Yb until seated on the second valve seat 65.

### Brake Actuator

As illustrated in FIG. 1, the brake actuator 23 includes the first hydraulic circuit 231 and the second hydraulic circuit 232. The first hydraulic circuit 231 is connected to the first flow path 331 of the hydraulic pressure generation device 22 and is connected to the wheel cylinders 11 for the front wheels FL and FR. Therefore, when the brake fluid is supplied from the master device 30 to the first hydraulic circuit 231 via the first flow path 331, the brake fluid is supplied to the wheel cylinders 11 for the front wheels FL and FR through the first hydraulic circuit 231. The first hydraulic circuit 231 is configured to be capable of individually adjusting the hydraulic pressure in the wheel cylinder 11 for the front wheel FL and the hydraulic pressure in the wheel cylinder 11 for the front wheel FR.

The second hydraulic circuit 232 is connected to the sixth flow path 58 of the hydraulic pressure generation device 22 and is connected to the wheel cylinders 11 for the rear wheels RL and RR. Therefore, when the brake fluid is supplied to the second hydraulic circuit 232 from the electric cylinder 51 via the sixth flow path 58, the brake fluid is supplied to the wheel cylinders 11 for the rear wheels RL and RR through the second hydraulic circuit 232. The second hydraulic circuit 232 is configured to be capable of individually adjusting the hydraulic pressure in the wheel cylinder 11 for the rear wheel RL and the hydraulic pressure in the wheel cylinder 11 for the rear wheel RR.

The first hydraulic circuit 231 and the second hydraulic circuit 232 each have a differential pressure adjustment valve 23A. The differential pressure adjustment valve 23A is disposed in the fluid path connecting the hydraulic pressure generation device 22 to the wheel cylinders 11. The differential pressure adjustment valve 23A is a solenoid valve that adjusts the differential pressure between the part of the fluid path on the hydraulic pressure generation device 22 side and the part of the fluid path on the wheel cylinder 11 side. Note that an example of the configuration of the first hydraulic circuit 231 and the second hydraulic circuit 232 is disclosed in JP 2023-20360 A. Of course, the first hydraulic circuit 231 and the second hydraulic circuit 232 may have configurations different from those disclosed in the above-mentioned publication.

### Detection System of Braking Device

As illustrated in FIGS. 1 and 2, the detection system of the braking device 20 includes a plurality of sensors. Detection signals from the sensors are input to the control device 80 of the braking device 20. The plurality of sensors include a plurality of hydraulic pressure sensors 351, 352, and 353 and a stroke sensor SE1.

The master hydraulic pressure sensor 351 detects the hydraulic pressure in the master chamber Rm. For example, the master hydraulic pressure sensor 351 is provided in the first flow path 331. The input hydraulic pressure sensor 352 detects the hydraulic pressure in the second fluid chamber R2. For example, the input hydraulic pressure sensor 352 is connected at a position between the first control valve 341 and the second fluid chamber R2 in the second flow path 332. The control pressure sensor 353 detects the hydraulic pressure of the brake fluid discharged from the electric cylinder 51. For example, the control pressure sensor 353 is provided near the output port 516 in the electric cylinder 51. As an example, FIG. 1 illustrates a configuration in which the control pressure sensor 353 is connected between the release valve 57 in the release flow path 56 and the output port 516. The stroke sensor SE1 detects the amount of operation of the brake operation member 21.

### Control Device

The control device 80 includes a processing circuit 81. For example, the processing circuit 81 is an electronic control device. In this case, the processing circuit 81 has a CPU 82 and a memory 83. The memory 83 stores a control program executed by the CPU 82. When the CPU 82 executes the control program, the processing circuit 81 operates the hydraulic pressure generation device 22 and the brake actuator 23. That is, the processing circuit 81 controls the various solenoid valves 341, 342, 551, and 57 and the electric motor 513 of the hydraulic pressure generation device 22, and the brake actuator 23.

When hydraulic pressure is being generated in the wheel cylinders 11 by the operation of the electric cylinder 51, the processing circuit 81 monitors whether or not power is being supplied from the power source to the electric motor 513 of the electric cylinder 51. The processing for monitoring whether or not power is being supplied from the power source to the electric motor 513 is referred to as power supply monitoring processing.

### Power Supply Monitoring Processing

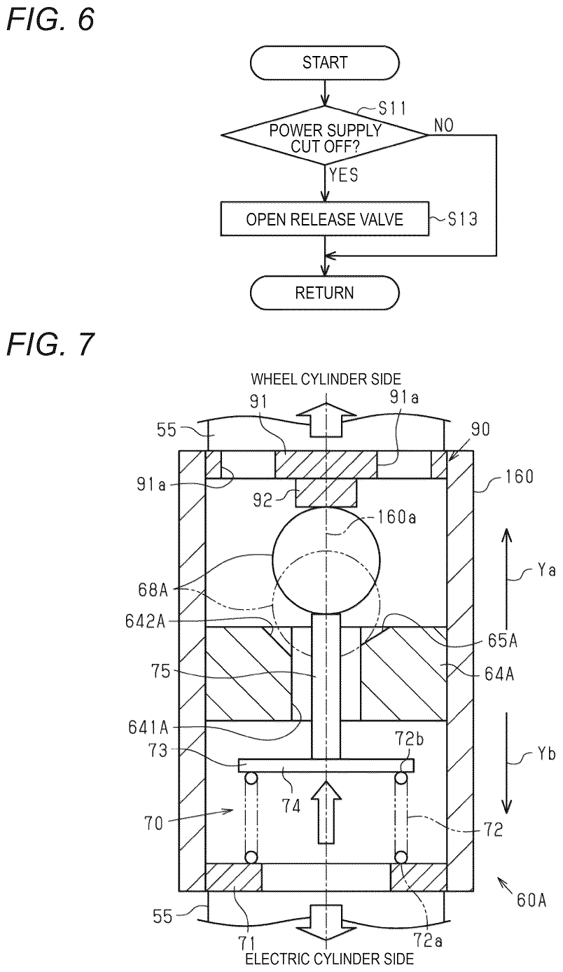

FIG. 6 is a flowchart illustrating power supply monitoring processing. When hydraulic pressure is being generated in the wheel cylinders 11 by the operation of the electric cylinder 51, the processing circuit 81 repeatedly executes the power supply monitoring processing at every predetermined control cycle.

As illustrated in FIG. 6, in step S11, the processing circuit 81 determines whether or not the power supply to the electric motor 513 has been cut off. For example, the processing circuit 81 can determine whether or not the power supply to the electric motor 513 has been cut off, by monitoring at least one of the current flowing through the power line of the electric motor 513 and the voltage applied to the electric motor 513. If the processing circuit 81 determines that the power supply to the electric motor 513 has been cut off (S11: YES), the processing proceeds to step S13.

In step S13, the processing circuit 81 opens the release valve 57. Thereafter, the processing circuit 81 ends the current processing.

Meanwhile, upon determining that the power supply to the electric motor 513 is not cut off in step S11 (S11: NO), the processing circuit 81 temporarily ends the current processing. That is, the processing circuit 81 does not open the release valve 57.

### Functions and Effects of Present Embodiment

When the brake operation member 21 is operated or the like to request deceleration of the vehicle, the processing circuit 81 derives a target braking force, which is the target value of the braking force. Then, the processing circuit 81 drives the electric motor 513 on the basis of the target braking force. Then, in the electric cylinder 51, the piston 512 moves linearly in the forward direction Za in response to the driving of the electric motor 513. As a result, the brake fluid is discharged from the hydraulic chamber Re in the cylinder 511 to the fifth flow path 55 through the output port 516. The brake fluid discharged from the output port 516 passes through the resistance generation part 60. In this case, since the brake fluid flows through the fifth flow path 55 in the pressurization direction Ya, the flow resistance of the resistance generation part 60 is relatively small. Part of the brake fluid having passed through the resistance generation part 60 flows into the servo chamber Rs of the master device 30 through the fifth flow path 55. The remaining brake fluid flows into the sixth flow path 58 from the first connection point 55a. The brake fluid flowing into the sixth flow path 58 passes through the second hydraulic circuit 232 and is supplied to the wheel cylinders 11 for the rear wheels RL and RR. As a result, the hydraulic pressure in the wheel cylinders 11 for the rear wheels RL and RR is increased, so that the braking force is generated at the rear wheels RL and RR. That is, in the present embodiment, the sixth flow path 58 is one of the “supply flow paths” through which the brake fluid flows toward the wheel cylinders 11 (second wheel cylinders) when the brake fluid in the cylinder 511 is discharged from the output port 516.

Meanwhile, in the master device 30, the hydraulic pressure in the servo chamber Rs is increased, causing the master piston 43 to move linearly forward. As a result, the hydraulic pressure in the master chamber Rm of the master device 30 is increased, so that the brake fluid is discharged from the master chamber Rm to the first flow path 331. The brake fluid flowing into the first flow path 331 passes through the first hydraulic circuit 231 and is supplied to the wheel cylinders 11 for the front wheels FL and FR. As a result, the hydraulic pressure in the wheel cylinders 11 for the front wheels FL and FR is increased, so that the braking force is generated at the front wheels FL and FR. That is, in the present embodiment, the first flow path 331 is one of the “supply flow paths” through which the brake fluid flows toward the wheel cylinders 11 (first wheel cylinders) when the brake fluid in the cylinder 511 is discharged from the output port 516.

When the power supply from the power source to the electric motor 513 is cut off in this situation where hydraulic pressure is being generated in the plurality of wheel cylinders 11, the brake fluid in the plurality of wheel cylinders 11 flows out toward the electric cylinder 51. That is, the brake fluid in the wheel cylinders 11 for the rear wheels RL and RR flows into the connection flow path 55c of the fifth flow path 55 via the second hydraulic circuit 232 and the sixth flow path 58. The brake fluid flows in the depressurization direction Yb through the connection flow path 55c and flows into the hydraulic chamber Re of the electric cylinder 51.

Furthermore, the brake fluid in the wheel cylinders 11 for the front wheels FL and FR returns to the master chamber Rm of the master device 30 via the first hydraulic circuit 231 and the first flow path 331. Then the master piston 43 moves linearly rearward by the fluid pressure in the master chamber Rm, so that the brake fluid in the servo chamber Rs is discharged to the first hydraulic flow path 55d of the fifth flow path 55. The brake fluid flows from the first hydraulic flow path 55d into the connection flow path 55c, then flows in the depressurization direction Yb through the connection flow path 55c, and enters the hydraulic chamber Re of the electric cylinder 51.

In the hydraulic pressure generation device 22, the resistance generation part 60 is disposed in the connection flow path 55c. The resistance generation part 60 is configured such that the flow resistance of the brake fluid flowing in the depressurization direction Yb through the connection flow path 55c is greater than the flow resistance of the brake fluid flowing in the pressurization direction Ya through the connection flow path 55c.

Therefore, the force of the brake fluid flowing in the depressurization direction Yb through the connection flow path 55c is reduced by the resistance generation part 60. In this state of reduced force, the brake fluid flows from the output port 516 into the hydraulic chamber Re. Therefore, even if the brake fluid flows into the hydraulic chamber Re from the output port 516, rapid linear movement of the piston 512 in the backward direction Zb is prevented. Therefore, the hydraulic pressure generation device 22 can reduce damage to the restriction member 518 when the piston 512 collides with the restriction member 518.

In the present embodiment, the following effects can be further obtained.

(1) The resistance generation part 60 is a mechanical component. That is, the resistance generation part 60 does not change the flow resistance by control. Therefore, when the brake fluid starts to flow in the depressurization direction Yb through the connection flow path 55c as described above, the flow resistance of the resistance generation part 60 immediately increases. Therefore, it is possible to suppress an increase in the moving speed of the piston 512 in the backward direction Zb at the initial stage when the brake fluid starts to flow backward into the hydraulic chamber Re through the output port 516. As a result, the hydraulic pressure generation device 22 can reduce damage to the restriction member 518 when the piston 512 collides with the restriction member 518.

(2) The resistance generation part 60 is disposed in the connection flow path 55c, which is the part of the fifth flow path 55 closer to the electric cylinder 51 than the first connection point 55a. Therefore, both the force of the brake fluid flowing out from the wheel cylinders 11 for the rear wheels RL and RR and the force of the brake fluid flowing out from the servo chamber Rs can be weakened by the single resistance generation part 60. That is, it is not necessary to provide a plurality of resistance generation parts 60 in the hydraulic pressure generation device 22.

(3) Even if the power supply from the power source to the electric motor 513 is cut off, power may still be supplied to the control device 80 and the release valve 57. In this case, when the power supply from the power source to the electric motor 513 is cut off as illustrated in FIG. 6, the control device 80 opens the release valve 57 to allow the brake fluid flowing through the fifth flow path 55 to flow out to the reservoir tank 24 via the release flow path 56. As a result, the amount of brake fluid flowing into the hydraulic chamber Re of the electric cylinder 51 decreases by the amount that at least part of the brake fluid flowing in the depressurization direction Yb through the fifth flow path 55 flows out to the reservoir tank 24. Therefore, the linear movement of the piston 512 in the backward direction Zb can be suppressed.

### Second Embodiment

A second embodiment of a hydraulic pressure generation device will be described with reference to FIGS. 7 to 9. Note that the second embodiment is different from the first embodiment in the configuration of the resistance generation part. In the following description, parts different from those of the first embodiment will be mainly described, and the same components as those of the first embodiment will be denoted by the same reference signs, and redundant description will be omitted.

### Configuration of Resistance Generation Part

The configuration of a resistance generation part 60A will be described with reference to FIG. 7.

The resistance generation part 60A is configured such that the flow resistance of the brake fluid flowing in the depressurization direction Yb through the fifth flow path 55 is greater than the flow resistance of the brake fluid flowing in the pressurization direction Ya through the fifth flow path 55. Specifically, the resistance generation part 60A includes a cylindrical body 160, a support part 90, a seat member 64A disposed in the depressurization direction Yb relative to the support part 90, a displacement member 68A displaced between the support part 90 and the seat member 64A, and a biasing part 70. The body 160 is installed such that the brake fluid flowing through the fifth flow path 55 passes through the interior of the body 160. That is, the body 160 has an axis 160a that coincides with the axis of the fifth flow path 55. The support part 90, the seat member 64A, the displacement member 68A, and the biasing part 70 are arranged within the body 160.

### Support Part

An example of the support part 90 will be described. The support part 90 has a support plate 91 disposed so as to close the pressurization direction Ya-side opening of the body 160. The support plate 91 is provided with a plurality of through-holes 91a through which the brake fluid passes. The plurality of through-holes 91a are arranged along the circumferential direction about the axis 160a of the body 160. The support part 90 also has a pedestal 92 on which the displacement member 68A is seated. The pedestal 92 is provided on the surface of the support plate 91 in the depressurization direction Yb. Specifically, the pedestal 92 is provided in the part of the support plate 91 further inward in the radial direction than the plurality of through-holes 91a.

Note that the support part 90 may have a similar configuration to the support filter 61F described in the first embodiment.

### Seat Member

The seat member 64A is formed with a valve seat 65A on which the displacement member 68A is seated, a through-hole 641A, and at least one groove 642A communicating with the through-hole 641A. The through-hole 641A extends in the axial direction of the seat member 64A and also serves as a through-hole through which the brake fluid passes. The at least one groove 642A extends radially outward from the communication part with the through-hole 641A. The valve seat 65A is provided at a position where the displacement member 68A displaced in the depressurization direction Yb can be seated. When the displacement member 68A is seated on the valve seat 65A, the through-hole 641A is closed by the displacement member 68A. However, even when the displacement member 68A is seated on the valve seat 65A, the groove 642A is not closed by the displacement member 68A. That is, even if the through-hole 641A is closed by the displacement member 68A, the flow of the brake fluid through the groove 642A is allowed. The flow path cross-sectional area of the groove 642A is sufficiently smaller than the flow path cross-sectional area of the through-hole 91a of the support part 90.

### Displacement Member

An example of the displacement member 68A is a spherical valve element. The displacement member 68A is displaced in a direction corresponding to the flow direction of the brake fluid in the fifth flow path 55 between the support part 90 and the seat member 64A. That is, when the brake fluid flows in the pressurization direction Ya through the fifth flow path 55, the displacement member 68A is separated from the seat member 64A and is displaced in the pressurization direction Ya until seated on the pedestal 92 of the support part 90.

Therefore, when the brake fluid flows in the pressurization direction Ya through the fifth flow path 55, the displacement member 68A is separated from the seat member 64A. Meanwhile, when the brake fluid flows in the depressurization direction Yb through the fifth flow path 55, the displacement member 68A is separated from the support part 90 and is displaced in the depressurization direction Yb until seated on the valve seat 65A of the seat member 64A.

### Biasing Part

The biasing part 70 biases the displacement member 68A in the pressurization direction Ya so as to separate the displacement member 68A from the seat member 64A.

An example of the configuration of the biasing part 70 will be described. The support part 90 includes an annular fixing member 71, a coil spring 72, and a pressing member 73. The fixing member 71 is disposed in the depressurization direction Yb relative to the seat member 64A, and is attached to the body 160. The coil spring 72 is located between the fixing member 71 and the seat member 64A. For example, one end 72a of the coil spring 72 is fixed to the fixing member 71. The other end 72b of the coil spring 72 is fixed to the pressing member 73. The coil spring 72 is disposed so as to compress in the depressurization direction Yb and extend in the pressurization direction Ya. The coil spring 72 is an example of an “elastic member”.

An example of the pressing member 73 has an input part 74 to which an elastic force from the coil spring 72 is input, and a rod part 75 that extends from the input part 74 in the pressurization direction Ya. In this case, the input part 74 is disposed in the depressurization direction Yb relative to the seat member 64A. The rod part 75 passes through the through-hole 641A of the seat member 64A. That is, the end of the rod part 75 in the depressurization direction Yb is located in the depressurization direction Yb relative to the seat member 64A. The end of the rod part 75 in the pressurization direction Ya is in contact with the displacement member 68A. Thus, the biasing part 70 can bias the displacement member 68A in the pressurization direction Ya.

When the brake fluid flows in the pressurization direction Ya through the fifth flow path 55, the displacement member 68A is pressed against the pedestal 92 of the support part 90 by the force received by the displacement member 68A from the brake fluid flowing in the pressurization direction Ya and the biasing force from the biasing part 70. In this case, the flow path cross-sectional area between the displacement member 68A and the seat member 64A is large. Therefore, the flow resistance to the brake fluid flowing in the pressurization direction Ya through the connection flow path 55c is small.

Meanwhile, when the brake fluid flows in the depressurization direction Yb through the fifth flow path 55, the displacement member 68A is located at a position where the force received by the displacement member 68A from the brake fluid flowing in the depressurization direction Yb and the biasing force from the biasing part 70 are balanced. That is, the greater the force received by the displacement member 68A from the brake fluid flowing in the depressurization direction Yb, the closer the displacement member 68A is to the seat member 64A. As the displacement member 68A approaches the seat member 64A, the flow path cross-sectional area between the displacement member 68A and the seat member 64A becomes narrower, so that the flow resistance to the brake fluid flowing in the depressurization direction Yb through the connection flow path 55c increases. Then, when the displacement member 68A is seated on the valve seat 65A of the seat member 64A, the flow resistance to the brake fluid flowing in the depressurization direction Yb through the connection flow path 55c is maximized.

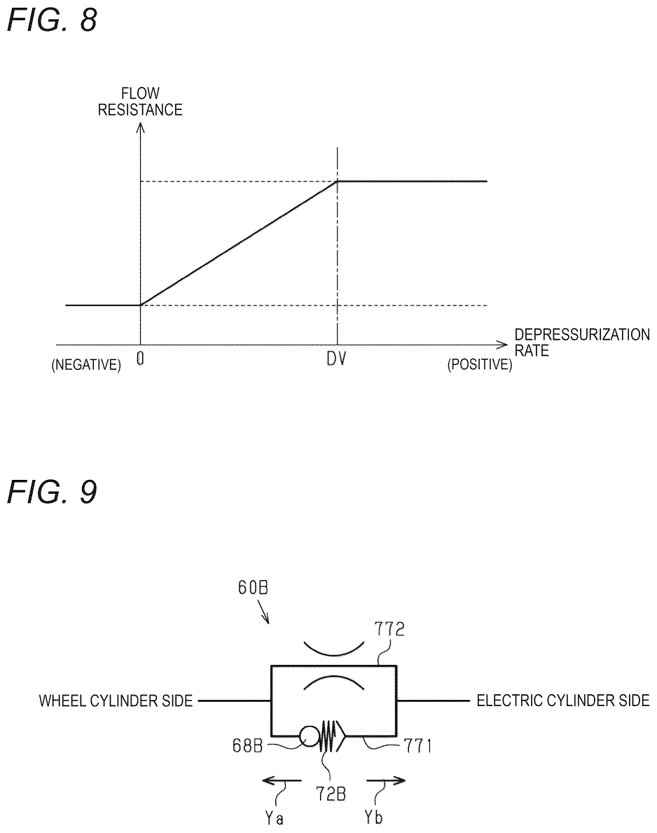

FIG. 8 illustrates the relationship between the depressurization rate, which is the flow velocity when the brake fluid flows in the depressurization direction Yb through the fifth flow path 55, and the flow resistance of the resistance generation part 60A. In FIG. 8, if the depressurization rate is negative, it indicates that the brake fluid is flowing in the pressurization direction Ya through the fifth flow path 55, and if the depressurization rate is positive, it indicates that the brake fluid is flowing in the depressurization direction Yb through the fifth flow path 55. Furthermore, the greater the absolute value of the depressurization rate, the greater the force received by the displacement member 68A from the brake fluid flowing through the fifth flow path 55.

If the depressurization rate is negative, the displacement member 68A is pressed against the pedestal 92 by the force received by the displacement member 68A from the brake fluid flowing in the pressurization direction Ya and the biasing force from the biasing part 70. In this case, since the flow path cross-sectional area between the displacement member 68A and the seat member 64A is maximized, the flow resistance to the brake fluid flowing through the fifth flow path 55 is minimized.

If the depressurization rate is positive, the greater the depressurization speed, the greater the force received by the displacement member 68A from the brake fluid flowing in the depressurization direction Yb. Therefore, in particular, if the depressurization rate is equal to or lower than a predetermined depressurization rate DV, the greater the depressurization rate, the closer the displacement member 68A is located to the seat member 64A. As the displacement member 68A approaches the seat member 64A, the flow path cross-sectional area between the displacement member 68A and the seat member 64A becomes smaller, so that the flow resistance to the brake fluid flowing through the fifth flow path 55 increases.

If the depressurization rate is greater than the predetermined depressurization rate DV, the force received by the displacement member 68A from the brake fluid flowing in the depressurization direction Yb becomes sufficiently greater than the biasing force from the biasing part 70. As a result, the displacement member 68A is seated on the valve seat 65A of the seat member 64A. In this case, since the flow path cross-sectional area between the displacement member 68A and the seat member 64A is minimized, the flow resistance to the brake fluid flowing through the fifth flow path 55 is maximized.

Here, the predetermined depressurization rate DV is preferably set as follows. That is, the depressurization rate when the following relational expression (D1) is satisfied is set as the predetermined depressurization rate DV.

$$Pressure loss \times seal diameter = spring load \qquad ( D1 )$$

In the relational expression (D1), the pressure loss is the pressure loss of the brake fluid flowing in the depressurization direction Yb when the displacement member 68A is seated on the valve seat 65A. The seal diameter is the diameter of the through-hole 641A of the seat member 64A. The spring load is the repulsive force of the coil spring 72 when the displacement member 68A is seated on the valve seat 65A.

### Functions and Effects of Present Embodiment

In the present embodiment, in addition to the effects equivalent to those of the first embodiment, the following effects can be further obtained.

(4) The resistance generation part 60A has the biasing part 70 that biases the displacement member 68A in the pressurization direction Ya so as to separate the displacement member 68A from the seat member 64A. Therefore, the position of the displacement member 68A in the body 160 is determined by the force received by the displacement member 68A from the brake fluid and the biasing force from the biasing part 70. For example, even when the brake fluid flows in the depressurization direction Yb through the fifth flow path 55, the displacement member 68A hardly approaches the seat member 64A if the flow rate (that is, depressurization rate) of the brake fluid is relatively low, due to the biasing force from the biasing part 70. As a result, the flow resistance to the brake fluid flowing in the depressurization direction Yb is maintained in a relatively small state. Therefore, in a case where the hydraulic pressure in the wheel cylinder 11 is gradually reduced by controlling the electric cylinder 51 with the control device 80, the hydraulic pressure in the wheel cylinder 11 is reduced at a rate corresponding to the moving speed of the piston 512 of the electric cylinder 51 in the backward direction Zb.

Meanwhile, for example, when the power supply from the power source to the electric motor 513 is cut off while hydraulic pressure is being generated in the plurality of wheel cylinders 11, the displacement member 68A is pushed by the brake fluid flowing with force in the depressurization direction Yb through the fifth flow path 55, so that the displacement member 68A approaches the seat member 64A against the biasing force from the biasing part 70. As a result, the flow resistance to the brake fluid flowing in the depressurization direction Yb increases. Thus, the force of the brake fluid flowing in the depressurization direction Yb through the connection flow path 55c is reduced by the resistance generation part 60A. In this state of reduced force, the brake fluid flows from the output port 516 into the hydraulic chamber Re. Therefore, even if the brake fluid flows into the hydraulic chamber Re from the output port 516, rapid linear movement of the piston 512 in the backward direction Zb is prevented.

Therefore, in a case where the hydraulic pressure in the wheel cylinder 11 is reduced by controlling the electric cylinder 51 with the control device 80, the hydraulic pressure generation device 22 can prevent the reduction speed of the hydraulic pressure in the wheel cylinder 11 from becoming excessively low relative to the speed corresponding to the operation of the electric cylinder 51. Meanwhile, if the power supply from the power source to the electric motor 513 is cut off, the hydraulic pressure generation device 22 can increase the flow resistance of the resistance generation part 60A, so that it is possible to suppress rapid linear movement of the piston 512 in the backward direction Zb within the electric cylinder 51.

### Modifications

The above plurality of embodiments can be implemented with the following modifications. The above-described embodiments and the following modifications can be implemented in combination with each other within a range not technically contradictory.
The biasing part of the resistance generation part 60A may have a configuration different from the biasing part 70 illustrated in FIG. 7 as long as the biasing part can bias the displacement member 68A in the pressurization direction Ya. For example, the biasing part does not need to include the pressing member 73 or a member corresponding to the pressing member 73. For example, the biasing part may be configured such that the coil spring can directly press the displacement member 68A in the pressurization direction Ya.

The biasing part may include an elastic member other than the coil spring 72 as long as the biasing part can bias the displacement member 68A in the pressurization direction Ya. For example, the biasing part may include a disc spring as an elastic member. In this case, it is preferable to place a disc spring between the displacement member 68A and the seat member. In this configuration, the seat member supports the disc spring. Furthermore, even if the displacement member 68A is displaced in the depressurization direction Yb, the contact of the displacement member 68A with the seat member is restricted by the disc spring. That is, the through-hole 641A of the seat member is not closed by the displacement member 68A. Therefore, it is not necessary to provide the groove 642A in the seat member 64A.
The biasing part of the resistance generation part 60A may be configured without including an elastic member as long as the biasing part can bias the displacement member 68A in the pressurization direction Ya. For example, the biasing part may include a permanent magnet that biases the displacement member 68A in the pressurization direction Ya by magnetic force. In this case, the displacement member 68A is preferably constituted by a magnetic member.
The resistance generation part may be a component having a configuration different from the resistance generation part 60 illustrated in FIG. 3 and the resistance generation part 60A illustrated in FIG. 7 as long as the resistance generation part is configured such that the flow resistance of the brake fluid flowing in the depressurization direction Yb through the supply flow path is greater than the flow resistance of the brake fluid flowing in the pressurization direction Ya through the supply flow path.

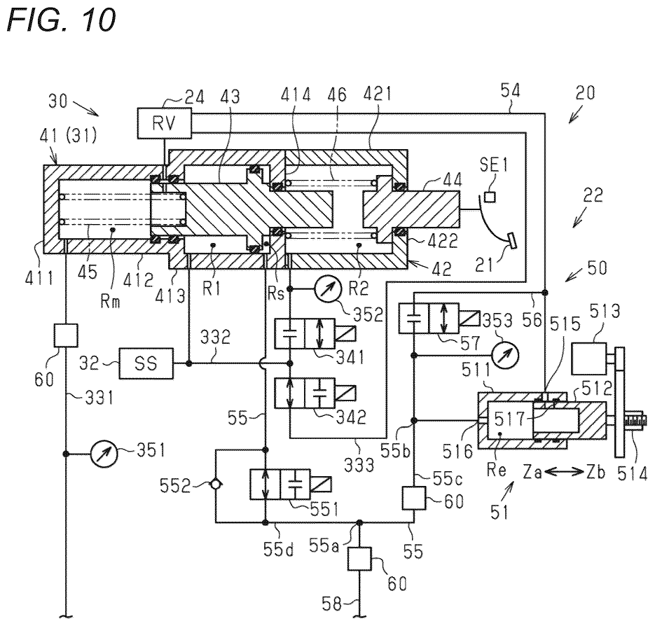

For example, the resistance generation part may have a configuration such as illustrated in FIG. 9. A resistance generation part 60B illustrated in FIG. 9 includes a plurality of flow paths 771 and 772 arranged in parallel. In the flow path 771 among the plurality of flow paths 771 and 772, there are arranged a displacement member 68B and an elastic member 72B that biases the displacement member 68B in the pressurization direction Ya. Meanwhile, in the flow path 772 among the plurality of flow paths 771 and 772, there is no configuration that allows the flow resistance of the brake fluid to be changed depending on the flow direction of the brake fluid.
The resistance generation part 60, 60A, or 60B may be disposed at a position different from the position illustrated in FIG. 1 within the connection flow path 55c. For example, as illustrated in FIG. 10, the resistance generation part 60, 60A, or 60B may be disposed between the first connection point 55a and the second connection point 55b in the connection flow path 55c.
Each of the sixth flow path 58 and the first flow path 331 is a supply flow path. Therefore, as illustrated in FIG. 10, the resistance generation part 60, 60A, or 60B may be disposed in each of the sixth flow path 58 and the first flow path 331. The resistance generation part 60, 60A, or 60B disposed in the sixth flow path 58 is referred to as a first resistance generation part, and the resistance generation part 60, 60A, or 60B disposed in the first flow path 331 is referred to as a second resistance generation part. In this case, the first resistance generation part is configured such that the flow resistance of the brake fluid flowing toward the master chamber Rm through the first flow path 331 is greater than the flow resistance of the brake fluid flowing toward the first hydraulic circuit 231 through the first flow path 331. The second resistance generation part is configured such that the flow resistance of the brake fluid flowing toward the fifth flow path 55 through the sixth flow path 58 is greater than the flow resistance of the brake fluid flowing toward the second hydraulic circuit 232 through the sixth flow path 58.

The flow resistance of the first resistance generation part when the brake fluid flows toward the master chamber Rm through the first flow path 331 is defined as a first flow resistance, and the flow resistance of the second resistance generation part when the brake fluid flows toward the fifth flow path 55 through the sixth flow path 58 is defined as a second flow resistance. At this time, the first flow resistance may be the same as or different from the second flow resistance. If the first flow resistance and the second flow resistance are individually set in this manner, the outflow degree of the brake fluid from the first wheel cylinder and the outflow degree of the brake fluid from the second wheel cylinder can be individually optimized.

Note that if the resistance generation part 60, 60A, or 60B is disposed in each of the sixth flow path 58 and the first flow path 331, it is not necessary to provide the resistance generation part 60, 60A, or 60B in the fifth flow path 55, or the resistance generation parts 60, 60A, or 60B may be provided in the fifth flow path 55.
If the resistance generation part 60, 60A, or 60B is disposed in one of the sixth flow path 58 and the first flow path 331, it is not necessary to place the resistance generation part 60, 60A, or 60B in the other flow path.

For example, as illustrated in FIG. 10, if the resistance generation part 60, 60A, or 60B is disposed in the sixth flow path 58 and the resistance generation part 60, 60A, or 60B is disposed between the servo chamber Rs and the differential pressure adjustment valve 551 in the fifth flow path 55, it is not necessary to place the resistance generation part 60, 60A, or 60B in the first flow path 331.
If the hydraulic pressure generation device 22 includes the resistance generation part 60, 60A, or 60B, the processing circuit 81 does not need to execute the power supply monitoring processing illustrated in FIG. 6.
The hydraulic pressure generation device 22 may have a configuration different from the configuration illustrated in FIG. 1 as long as it includes an electric cylinder.
The processing circuit 81 is not limited to one equipped with a CPU and ROM and executing software processing. That is, the processing circuit 81 need only have one of the following configurations (a), (b), and (c).
(a) The processing circuit 81 includes one or more processors that execute various processes in accordance with a computer program. The processors include a CPU and memory such as RAM and ROM. The memory stores program code or commands configured to cause the CPU to execute processing. The memory, that is, computer-readable medium, includes any available medium that can be accessed by a general-purpose or dedicated computer.
(b) The processing circuit 81 includes one or more dedicated hardware circuits that execute various processes. Examples of the dedicated hardware circuits include application-specific integrated circuits, that is, ASICS or FPGAS. Note that the ASIC is an abbreviation for “Application Specific Integrated Circuit” and the FPGA is an abbreviation for “Field Programmable Gate Array.”
(c) The processing circuit 81 includes a processor that executes some of various processes in accordance with a computer program, and a dedicated hardware circuit that executes the remaining processes.

Note that the expression “at least one” used herein means “one or more” desired options. As an example, the expression “at least one” used herein means “only one option” or “both options” if there are two options. As another example, the expression “at least one” as used herein means “only one option” or “any combination of two or more options” if there are three or more options.

1. A hydraulic pressure generation device for adjusting hydraulic pressure in a wheel cylinder provided in a vehicle, the hydraulic pressure generation device comprising:
an electric cylinder configured to discharge brake fluid from inside the cylinder to an outside through an output port by moving a piston within the cylinder in response to driving of the electric motor; and
a supply flow path through which the brake fluid flows toward the wheel cylinder when the brake fluid in the cylinder is discharged from the output port, wherein
among flow directions of the brake fluid in the supply flow path, a flow of the brake fluid toward the wheel cylinder is a pressurization direction, and a direction opposite to the pressurization direction is a depressurization direction, and
the supply flow path is provided with a resistance generation part that is configured such that a flow resistance of the brake fluid flowing in the depressurization direction through the supply flow path is greater than a flow resistance of the brake fluid flowing in the pressurization direction through the supply flow path.

2. The hydraulic pressure generation device according to claim 1, wherein
the vehicle includes a plurality of first wheel cylinders and a plurality of second wheel cylinders as the wheel cylinders, a first hydraulic circuit connecting the hydraulic pressure generation device to the plurality of first wheel cylinders, and a second hydraulic circuit connecting the hydraulic pressure generation device to the plurality of second wheel cylinders,
the hydraulic pressure generation device has, as the supply flow path, a connection flow path connected to the output port, a first hydraulic flow path for supplying the brake fluid to the first hydraulic circuit, and a second hydraulic flow path for supplying the brake fluid to the second hydraulic circuit,
both the first hydraulic flow path and the second hydraulic flow path are connected to the connection flow path via a connection point, and
the resistance generation part is disposed in the connection flow path.

3. The hydraulic pressure generation device according to claim 2, wherein
the resistance generation part has
a valve seat, and a valve element that is displaceable in a direction corresponding to the flow direction of the brake fluid in the supply flow path, and that is seated on the valve seat by the flow of the brake fluid in the depressurization direction and is separated from the valve seat by the flow of the brake fluid in the pressurization direction,
the valve seat is formed with a groove that allows the brake fluid to flow even when the valve element is seated on the valve seat,
if the brake fluid flows in the depressurization direction through the supply flow path, the valve element is seated on the valve seat, and the brake fluid flows in the groove, and
if the brake fluid flows in the pressurization direction through the supply flow path, the valve element is separated from the valve seat, and a flow path cross-sectional area through which the brake fluid flows is expanded.

4. The hydraulic pressure generation device according to claim 2, wherein
the resistance generation part has:
a seat member having a through-hole through which the brake fluid flows in a direction corresponding to the flow direction of the brake fluid in the supply flow path;
a displacement member that is displaceable in a direction corresponding to the flow direction of the brake fluid in the supply flow path, the displacement member being configured to increase the flow resistance of the brake fluid by approaching the seat member when the brake fluid flows in the depressurization direction through the supply flow path, and to decrease the flow resistance of the brake fluid by separating from the seat member when the brake fluid flows in the pressurization direction through the supply flow path; and
a biasing part configured to bias the displacement member in the pressurization direction so as to separate the displacement member from the seat member.

5. The hydraulic pressure generation device according to claim 4, wherein
the seat member is provided with a valve seat on which the displacement member is seated, and is formed with a groove that allows the brake fluid to flow even when the displacement member is seated on the valve seat.

6. The hydraulic pressure generation device according to claim 4, wherein
the biasing part includes an elastic member.

7. The hydraulic pressure generation device according to claim 1, wherein
the resistance generation part has:
a seat member having a through-hole through which the brake fluid flows in a direction corresponding to the flow direction of the brake fluid in the supply flow path;
a displacement member that is displaceable in a direction corresponding to the flow direction of the brake fluid in the supply flow path, the displacement member being configured to increase the flow resistance of the brake fluid by approaching the seat member when the brake fluid flows in the depressurization direction through the supply flow path, and to decrease the flow resistance of the brake fluid by separating from the seat member when the brake fluid flows in the pressurization direction through the supply flow path; and
a biasing part configured to bias the displacement member in the pressurization direction so as to separate the displacement member from the seat member.

8. The hydraulic pressure generation device according to claim 7, wherein the seat member is provided with a valve seat on which the displacement member is seated, and is formed with a groove that allows the brake fluid to flow even when the displacement member is seated on the valve seat.

9. The hydraulic pressure generation device according to claim 7, wherein the biasing part includes an elastic member.

10. The hydraulic pressure generation device according to claim 1, wherein
the resistance generation part has
a valve seat, and a valve element that is displaceable in a direction corresponding to the flow direction of the brake fluid in the supply flow path, and that is seated on the valve seat by the flow of the brake fluid in the depressurization direction and is separated from the valve seat by the flow of the brake fluid in the pressurization direction,
the valve seat is formed with a groove that allows the brake fluid to flow even when the valve element is seated on the valve seat,
if the brake fluid flows in the depressurization direction through the supply flow path, the valve element is seated on the valve seat, and the brake fluid flows in the groove, and
if the brake fluid flows in the pressurization direction through the supply flow path, the valve element is separated from the valve seat, and a flow path cross-sectional area through which the brake fluid flows is expanded.
